(19) United States
(12) Patent Application Publication
(10) Pub. No.: US 2007/0285480 A1
(43) Pub. Date: Dec. 13, 2007

(54) Ink extraction apparatus and ink extraction method

(75) Inventor: Saburou Fujita, Shizuoka (JP)

Correspondence Address: KANESAKA BERNER AND PARTNERS LLP, 1700 DIAGONAL RD, SUITE 310, ALEXANDRIA, VA, 22314-2848, US

(73) Assignee: ALPHA ENGINEERING INC., Shizuoka (JP)

(21) Appl. No.: 11/806,725

(22) Filed: Jun. 4, 2007

(30) Foreign Application Priority Data
Jun. 8, 2006 (JP) 2006-159174
May 8, 2007 (JP) 2007-122932

(51) Int. Cl. B41J 2/175

(52) U.S. Cl. 347/85

(57) ABSTRACT

This invention provides an ink extraction apparatus that is capable of boring a hole in an ink can by a simple means and of preventing leakage of ink when ink is extracted from the ink can. The ink extraction apparatus 1 comprises a base 8 having an opening portion 8a; an annular sealing member of the bottom of the can 9 provided around the exterior of the opening portion 8a; a cylindrical member 10 whose bottom end makes contact with the bottom of an ink can 3 positioned on the base 8; a cylindrical attachment member 11 provided with a cylindrical member 10, an advancing member 12 which is provided to be capable of advancing or retracting within the cylindrical member 10 while the bottom end of the cylindrical member 10 is located between the opening portion 8a on the base 8 and the annular sealing member 9, and which has a projection 12a for making a hole 4 in the bottom of the ink can 3 at a front end thereof; a plurality of rod-like members 17 connected to the connecting member 2; a connecting member 12 for connecting the other ends of the plural rod-like members 17, and a lowering means D which lowers the connecting member 18 toward the opening portion 8a.

### BACKGROUND OF THE INVENTION

1. Field of the Invention

The present invention relates to an ink extraction apparatus and an ink extraction method, and more particularly to an ink extraction apparatus which opens an ink can by a simple means and which can prevent leakage of ink while ink is being extracted from the ink can, and an ink extraction method.

2. Description of Related Art

The inventor of the present invention has already disclosed an ink extraction apparatus which opens an ink can so as to extract ink from within the ink can by compressing the same ink can (see patent document).

First, with the bottom of the ink can facing in an upward direction, a hole for extracting ink is made on the bottom of the ink can by use of a boring tool and next, a platen on which the ink can is to be positioned (member attached to the bottom) is attached to the ink can by means of adhesive agent.

In order to prevent leakage of ink from between the platen, on which the ink can is to be positioned and the ink can itself, the degree of viscosity of the aforementioned adhesive agent can be intensified. However, if the degree of viscosity is intensified to an excessive degree, the ink can cannot be easily separated from the platen after extraction of ink has been completed. This constitutes a disadvantage insofar that the platen cannot be recycled.

To eliminate this deficiency, a method exists of reducing the level of viscosity of the adhesive agent mentioned above.

However, because leakage of ink occurs when the viscosity of the adhesive agent is reduced, a new problem occurs insofar that the gap between the platen, on which the ink can is to be positioned and the ink can itself needs to be sealed with adhesive tape.
Patent document 1: Japanese Patent No. 3497160

### SUMMARY OF THE INVENTION

An object of the present invention is to provide an ink extraction apparatus and an ink extraction method by virtue of which the above-described problems can be solved.

In the ink extraction apparatus of claim 1, as viewed in plan view the bottom end of the cylindrical member is a simple means which is positioned between the opening portion on the base and the annular sealing member in order to bring the annular sealing member into a pressure contact with the bottom portion of the ink can, thereby enhancing the level of sealing performance. In other words, leakage of ink can be prevented while a hole is being bored in the bottom portion of the ink can and ink can be extracted from within the ink can through a communication hole in the cylindrical member, through the opening portion and through a hole that is provided at the bottom of the ink can.

With the bottom end of the cylindrical member maintained in contact with the bottom portion of the ink can that is positioned on the base, a hole can be bored in the bottom of the ink can with a projection at the front end of an advancing member provided within the cylindrical member. Cut-out pieces in the bottom portion of the ink can that are generated together with the hole are directed from the interior of the ink can towards the exterior and do not constitute an obstacle when ink within the ink can is forced out with a contact member that is being lowered (In contrast, when a hole is made in the bottom portion of the ink can from the interior to the exterior, cut-out pieces in the bottom portion in which a hole has been bored are located within the ink can. Consequently, when ink is forced out with a contact member that is being lowered, the cut-out pieces create a problem insofar that they block extraction of the ink).

In the ink extraction apparatus of claim 2, in addition to the effects of claim 1, the bottom of the ink can is brought into a pressure contact with the annular sealing member of the bottom of the can, by intensifying the degree of tightening of the female screw of the nut onto the male screw so as to enhance the level of sealing performance between the bottom portion of the ink can and the annular sealing member of the bottom of the can thereby preventing leakage of ink.

In the ink extraction apparatus of claim 3, in addition to the effects of claim 1, the bottom of the ink can is brought into a pressure contact with the annular sealing member of the bottom of the can by intensifying the degree of tightening of the female screw of the nut onto the male screw so as to improve the level of sealing performance between the bottom portion of the ink can and the annular sealing member of the bottom of the can thereby preventing leakage of ink.

In the ink extraction apparatus of claim 4, in addition to the effects of claim 1, the bottom portion of the ink can is brought into a pressure contact with the annular sealing member of the bottom of the can by intensifying the degree of tightening in the process of fastening the male screw of the male screw body onto the female screw so as to improve the level of sealing performance between the bottom of the ink can and the annular sealing member of the bottom of the can, thereby preventing leakage of ink.

In the ink extraction apparatus of claim 5, in addition to the effects of the invention of claim 1, the advancing member has communication passages that connect the projection of the advancing member with a side portion of the advancing member. Consequently, a hole bored in the bottom portion of the ink can with the projection of the advancing member, and when the advancing member has advanced to a position where the communication passage, which connects the projection of the advancing member with a side portion of the advancing member, makes contact with the communication hole, which connects the interior of the cylindrical member with the exterior, the process can progress to the next step of extracting ink without any need for the advancing member to move backwards, thereby enhancing the level of operational efficiency.

In the ink extraction apparatus of claim 5, a hole-boring member of the bottom of the can is located in the interior of the annular sealing member and leakage of ink can be prevented while a hole is being bored in the bottom of the ink can. Further, ink within the ink can can be extracted through the communication hole in the hole-boring member of the bottom of the can.

In a prior invention, in the course of extracting ink, the advancing member (hole-boring member of the bottom of the can) needs to be brought back upwards so as to establish a state of connection with a communication hole in the cylindrical member, a hole provided in the bottom portion of the ink can and with the opening portion in the base. However, in the ink extraction apparatus of claim 5, when a hole is bored in the bottom portion of the ink can with the projection at the front end of the hole-boring member of the bottom of the can, the hole-boring member of the bottom of the can does not need to be brought back in an upward direction and the kind of cylindrical member mentioned in the previous embodiment is not necessary. Further, cut-out pieces generated at the bottom of the ink can by the projection at the front end of the hole-boring member of the bottom of the can are directed from the interior towards the exterior and do not create any problems when ink within the ink can is forced out of the ink can with a lid member that is lowered (this is because, when a hole is bored in the bottom portion of the ink can from the exterior to the interior of the ink can, the cut-out pieces in the bottom portion in which a hole has been bored are located inside, and when ink is forced out with a contact member that is lowered, a problem occurs that the cut-out pieces obstruct extraction of ink.)

According to the ink extraction method of claim 6, with the annular sealing member of the bottom of the can maintaining a pressure contact with the bottom portion of the ink can, in other words, when the annular sealing member is maintained in a pressure contact with the bottom portion of the ink can so as to intensify the level of sealing performance, a series of steps of boring holes and extracting ink can be carried out. Further, with the bottom end of the cylindrical member used in boring kept in a state of a pressure contact with the bottom portion of the ink can, in other words, without the cylindrical member being moved, an operational procedure can be executed, and a highly satisfactory level of operational efficiency thereby can be secured.

According to the ink extraction method of claim 7, in addition to the effects of claim 6, in the positioning step, the ink can is moved in such a way that the outer periphery of the contact member that is lowered along the inner wall of the ink can and positioned on the base makes contact with the entire inner wall of the ink can. Consequently, positioning is facilitated.

According to the ink extraction method of claim 8, the hole-boring member of the bottom of the can is located inside of the annular sealing member, and leakage of ink can be prevented while a hole is being bored in the bottom portion of the ink can, and ink can be extracted through the communication hole in the hole-boring member of the bottom of the can.

Further, although in embodiments of prior art, when ink is extracted, the advancing member needs to be brought back in an upward direction so that a state of connection is established among the communication hole in the cylindrical member, the hole provided in the bottom portion of the ink can and the opening portion in the base, when a hole is bored in the bottom of the ink can with the projection at the front end of the hole-boring member of the bottom of the can, the hole-boring member of the bottom of the can does not need to be brought back upward, and further, because cut-out pieces generated in the bottom of the ink can by the projection at the front end of the hole-boring member of the bottom of the can are directed from the interior of the ink can to the exterior, no trouble arises in extracting ink from within the ink can with the lid member that is lowered (because, when a hole is bored in the bottom of the ink can from the exterior of the ink can towards the interior, the cut-out pieces in the portion in which a hole has been bored are located inside the ink can, and in consequence cut-out pieces create a problem insofar that extraction of ink is obstructed when the ink is forced out with contact member that is being lowered).

### BRIEF DESCRIPTION OF THE DRAWINGS

FIG. 1 is a schematic front view showing an ink extraction apparatus according to an embodiment of the present invention;

FIG. 2 is a schematic perspective view showing part of the ink extraction apparatus of FIG. 1;

FIG. 3 is a schematic partially sectional view showing a condition in which an ink can is placed on the ink extraction apparatus of FIG. 1;

FIG. 4 is a schematic partially sectional view showing a condition in which the ink can of FIG. 3 is positioned with a lid member;

FIG. 5 is a schematic sectional view showing a condition in which a hole is being bored in the bottom of the ink can;

FIG. 6 is a schematic partially enlarged sectional view showing part of FIG. 5 in an enlarged form;

FIG. 7 is a schematic partially sectional view of an advancing member of FIG. 5;

FIG. 8 is a schematic sectional view showing a condition in which after a hole has been bored in the bottom of the ink can, the advancing member is moved from a communication hole;

FIG. 9(a) is a schematic sectional view showing extraction condition in which ink is extracted and FIG. 9(b) is a schematic sectional view taken along the line X-X of FIG. 9(a), in which, as in a plan view, the bottom end of the cylindrical member is located the inside the annular sealing member in such a way that the center of the cylindrical member coincides with the center of the opening portion on the base;

FIG. 10 is a schematic view of a stopper body of another embodiment that is different from the stopper body of FIG. 2;

FIG. 11 is a schematic view of a stopper body of another embodiment that is different from the stopper body of FIG. 10;

FIG. 12 shows other embodiment that is different from the ink extraction apparatus of FIG. 1 and is a schematic sectional view showing a condition before a hole is bored in the bottom of the ink can;

FIG. 13 is a schematic sectional view showing a condition of the ink extraction apparatus of FIG. 12 when a hole is bored in the bottom of the ink can;

FIG. 14 is a schematic partially enlarged sectional view showing part of FIG. 13 in enlarged form;

FIG. 15 is a schematic front view of a condition in which a projection of the boring member of the bottom of the can of FIG. 12 is attached to the attachment member in such a way that it droops downward;

FIG. 16 is a schematic bottom face diagram of the boring member of the bottom of the can of FIG. 15; and

FIG. 17 is a schematic sectional view taken along the line 17-17 of FIG. 16.

### DESCRIPTION OF THE PREFERRED EMBODIMENTS

An ink extraction apparatus and an ink extraction method according to an embodiment of the present invention will now be described with reference to the accompanying drawings.

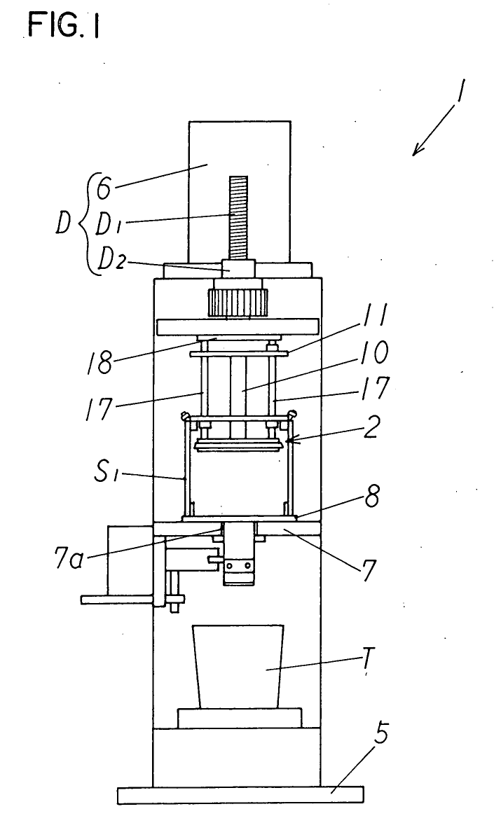

Reference numeral 1 in FIG. 1 denotes an ink extraction apparatus which forces out ink from within an ink can 3 by lowering a lid member 2 so as to extract a predetermined amount of ink out of the ink can 3 through a hole provided at the bottom of the ink can 3. As shown in FIG. 1, the ink extraction apparatus 1 generally comprises a base 5 located in a downward position, a motor 6 located in an upward position and a mounting base 7 that is located between the base 5 and the motor 6. Reference numeral 7a denotes an edge-opening portion whose edge is opened to receive a valve body B provided on the mounting base 7 and that will be described later.

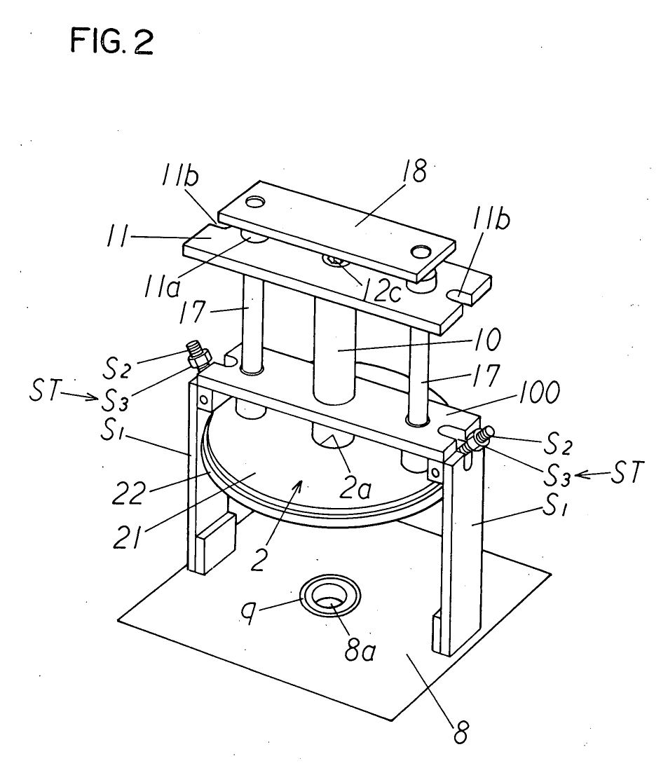

This mounting base 7 is used for mounting a base 8 on which the ink can 3 is positioned and, as shown in FIG. 2, the base 8 has an opening portion 8a at its center and an annular sealing member of the bottom of the can 9 (for example, an O-ring) provided on the outer circumference of the opening portion 8a.

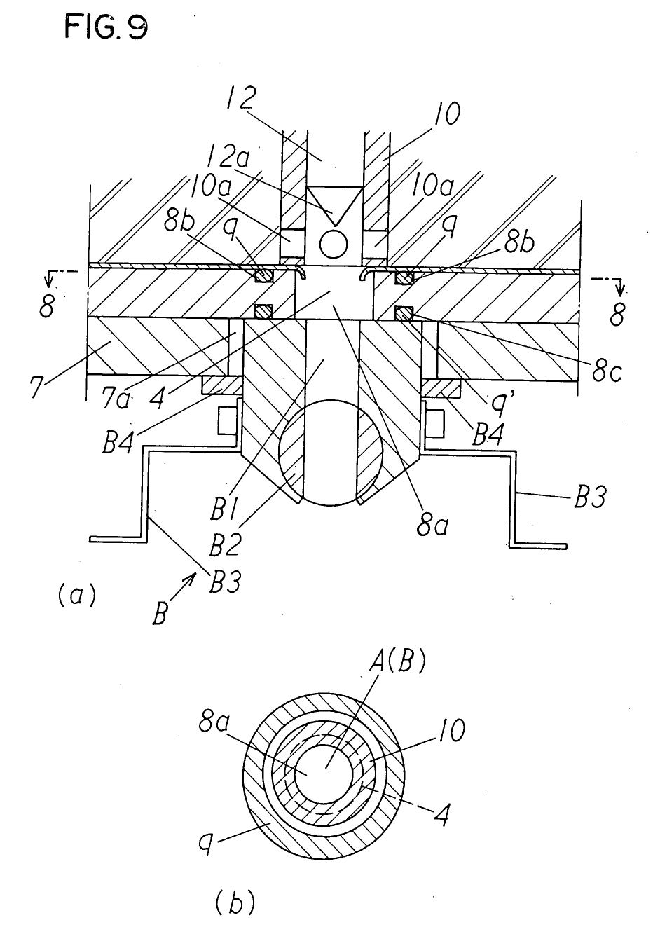

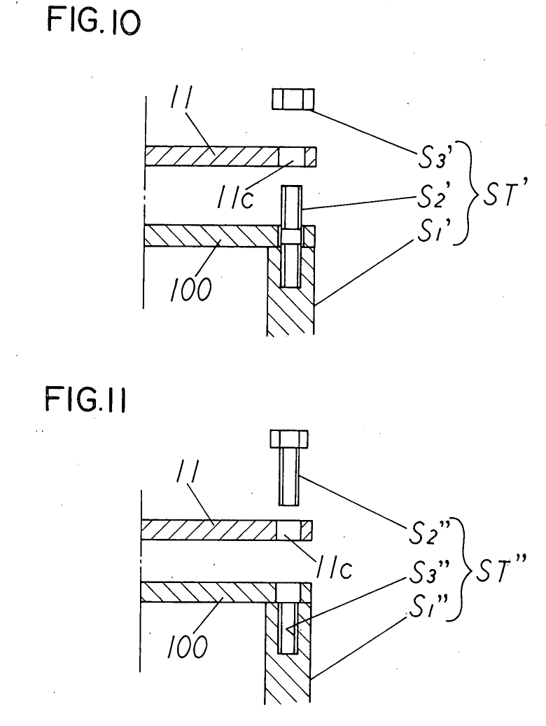

This annular sealing member of the bottom of the can 9 is embedded in an annular concave groove 8b (see FIG. 9) provided in the periphery, outside of the opening portion 8a of the base 8, on a side on which the ink can 3 of the base 8 is positioned, and a top portion projects from the face of the base 8.

Further, a rear face side concave groove 8c is provided on the rear face of the base 8 and on a valve body sealing member 9′ (for example, an O-ring) is provided on the rear face concave groove 8c, in order to seal a face which connects the rear face of the base 8 with a valve body B that will be described later.

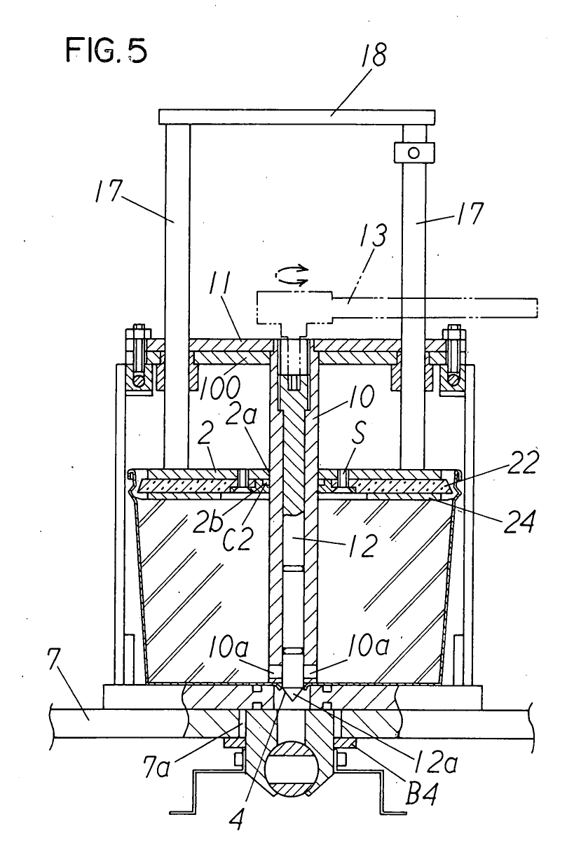

Reference numeral 10 in FIG. 5 denotes a cylindrical member whose bottom end makes contact with the bottom of the ink can 3 that is positioned on the base 8, and the cylindrical member 10 is installed onto a cylindrical attachment member 11 at its outer periphery on the top end. This cylindrical attachment member 11 is installed in such a way that the cylindrical member 10 droops downward.

Further a plurality of communication holes 10a which connect the interior of the cylindrical member 10 with the exterior are provided at positions near to the bottom end of the cylindrical member 10.

The bottom end of the cylindrical member 10 is positioned the interior the annular sealing member of the bottom of the can 9, as seen in its plan view and the center A of the cylindrical member 10 coincides with the center B of the opening portion 8a [FIGS. 9(a), (b)]

As will be described later, the annular sealing member of the bottom of the can 9 makes a pressure contact with the bottom of the ink can 3 so as to enhance the level of sealing performance.

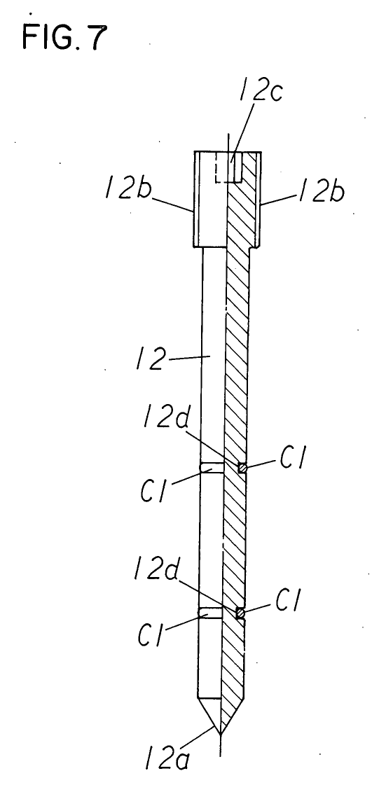

As shown in FIGS. 5-8, the cylindrical member 10 includes an advancing member 12 which is provided so as to be freely movable within the cylindrical member 10 and has a projection 12a for making a hole that makes contact with the opening portion 8a at the bottom of the ink can 3 at its front end.

The advancing member 12 has a male screw 12b which is fastened onto a female screw provided on the inner periphery of the cylindrical member 10, and when the front end of a tool 13 is engaged with a concave portion 12c (for example, a hexagonal portion as seen in plan view) provided at the top end, and the tool 13 is rotated clockwise, the advancing member 12 is moved in such a way that a front end thereof approaches the bottom of the ink can 3, and when the tool 13 is rotated counterclockwise, the advancing member 12 is moved in such a way that the front end thereof moves away form the bottom of the ink can 3.

C1 denotes a first sealing member (for example, an O-ring) which seals between the outer periphery of the advancing member 12 and the inner periphery of the cylindrical member 10, and this first sealing member C1 is embedded in an annular concave groove 12d that is provided on the side face of the advancing member 12 in such a way that it projects from the concave groove 12d and makes contact with the inner periphery of the cylindrical member 10.

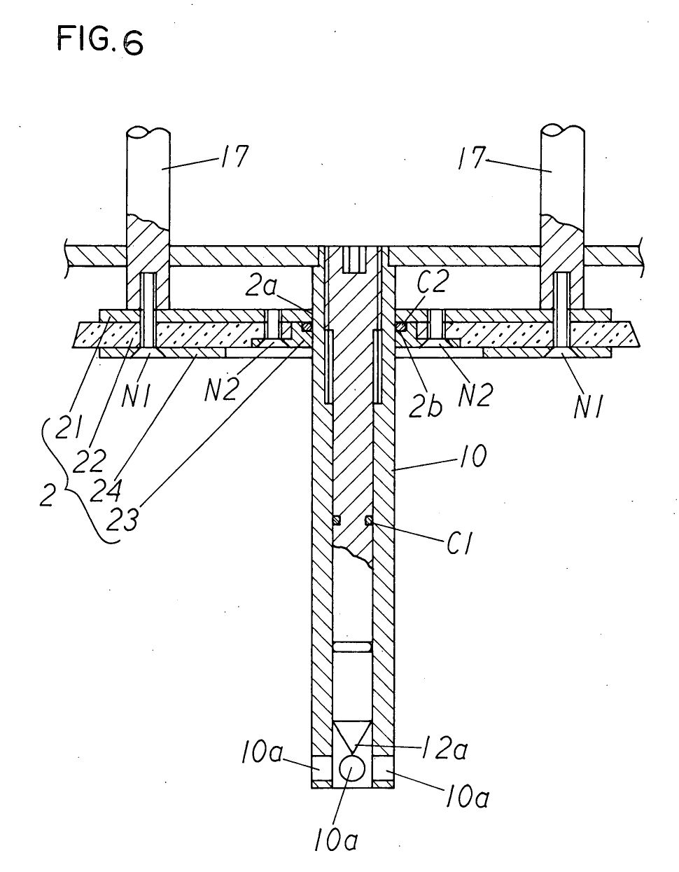

As shown in FIGS. 5, 6, the lid member 2 has a hole 2a which is located below the cylindrical attachment member 11, and through which the outer periphery of the cylindrical member 10 passes; an entire circumference of the outer periphery makes contact with the inner wall of the ink can 3 and is located above the ink in the ink can 3.

The lid member 2 comprises a lid member main body 21, a donut-like member 22 that, by virtue of being made with synthetic resin, (for example, urethane) provided on the rear face of the lid member main body 21, has elasticity an the interior member 23 located the inside of this donut-like member 22 and an the outside member 24 located outside the donut-like member 22.

The lid member main body 21, the donut-like member 22 and the outside member 24 are connected to a rod-like member 17 that will be described later. Further, the inner peripheral edge portion of the donut-like member 22 is attached to the lid member main body 21 with the interior member 23 through the screw N2. A clearance between the inner periphery of the hole 2a on the lid member 2 and the outer periphery of the cylindrical member 10 is sealed with second sealing member C2 (for example, an O-ring). This second sealing member C2 is embedded in the annular concave groove 2b provided on the inner periphery of the hole 2a of the lid member 2, and projects form the concave groove 2b so as to make contact with the outer periphery of the cylindrical member 10.

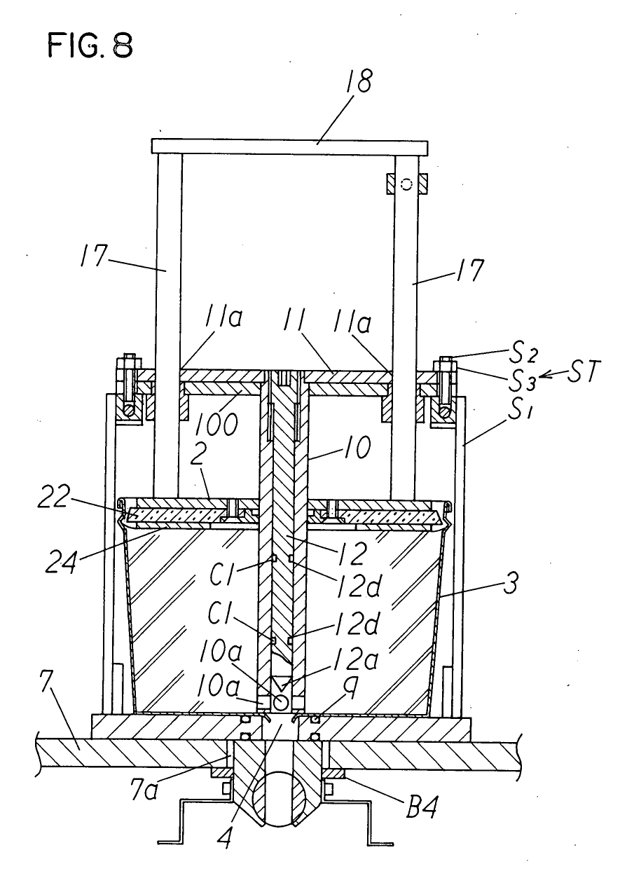

Reference numeral 17 shown in FIG. 8 denotes plural rod-like members connected to the lid member 2, and the other ends of the plural rod-like members 17 are connected to a connecting member 18.

In other words, an end of each of the plural rod-like members 17 is connected to the lid member 2 while the other end of each of the plural rod-like members 17 is connected to the connecting member 18, and the halfway portion of each of the plural rod-like members penetrates each of plural holes 11a provided on the cylindrical attachment member 11.

ST shown in FIG. 2 denotes a stopper body which, in order to maintain a condition in which the bottom end of the cylindrical member 10 is in contact with the bottom of the ink can 3 positioned on the base 8, blocks the cylindrical member 10 from moving in a direction away from the opening portion 8a,. More specifically, the stopper body ST comprises upright members S1 that are erected from the base 8, male screws S2 attached rotatably to the upright members S1 and nuts S3 having female screws which are fastened onto the male screws S2. As shown in FIG. 8, by fastening the female screws onto the male screws S2, the bottom of the ink can 3 is brought into a pressure contact with the annular sealing member of the bottom of the can 9 through the cylindrical attachment member 11 and the cylindrical member 10.

As a result, the female screws of the nuts S3 can be tightened firmly so as to fasten onto the male screws S2, and in consequence the bottom of the ink can 3 can be brought into a pressure contact with the annular sealing member of the bottom of the can 9. Consequently, the level of sealing performance between the bottom of the ink can 3 and the annular sealing member of the bottom of the can 9 is enhanced, and as a result, when the lid member 2 is lowered, a specified amount of ink can be extracted out of the ink can 3 through a hole 4 that is provided on the bottom of the ink can 3, and leakage of ink can thereby be prevented.

Further, reference numeral 100 in FIG. 2 denotes a reinforcement member provided between an upright member S1 and another upright member S1.

Reference numeral D in FIG. 1 denotes a lowering means which lowers the connecting member 18 toward the opening portion 8a. More specifically, in the lowering means D, the front end of a male screw D1 makes contact with the connecting member 18 and the connecting member 18 is moved in a downward direction, when it is pressed by the male screw D1, which droops downward.

Reference numeral D2 denotes a female screw which is fastened onto a male screw D1, rotation from the motor 6 is decelerated by gears (not shown) and a clockwise rotation is transmitted to the male screw D1 in such a way the front end of the male screw D1 is lowered through the female screw D2 at a fixed position.

To move the front end of the male screw D1 away from the connecting member 18, the rotation of the motor 6 can be reversed.

Reference numeral B in FIG. 9 denotes a valve body attached to the rear face of the base 8. The valve body B communicates with the opening portion 8a on the base 8 and includes a passage B1 that faces outward and a valve B2 which opens and closes this passage B1. Reference numeral B3 denotes legs which support the valve body B. Reference numeral B4 denotes an engaging member provided on the valve body B for fitting onto the rear face of the base 8. The reason why an engaging member B4 is provided is as follows. When a base 8 equipped with a valve body B by means of the edge-opening portion 7a on the mounting base 7 is positioned on the mounting base 7, ink within the ink can 3 is extracted by lowering the lid member 2. Thereafter, when the lid member 2 is lifted up, the ink can 3 is prevented from moving away from the base 8, thus facilitating separation of the lid member 2 from the interior of the ink can 3 after extraction has been completed.

Thus, an ink can 3 containing ink with its lid opened is positioned on the base 8, and the bottom end of the cylindrical member 10 is brought into contact with the bottom of the ink can 3 that is positioned on a base 8 that has opening portion 8a, in such a way that the center of the cylindrical member 10 coincides with the center of the opening portion 8a (positioning process).

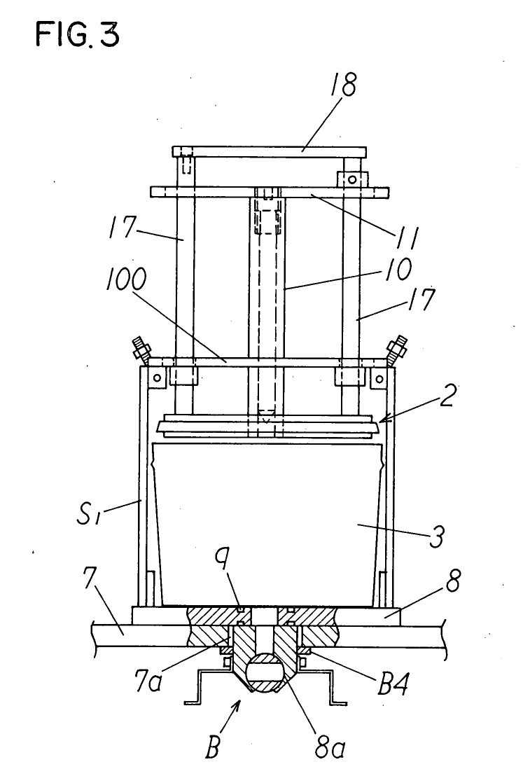

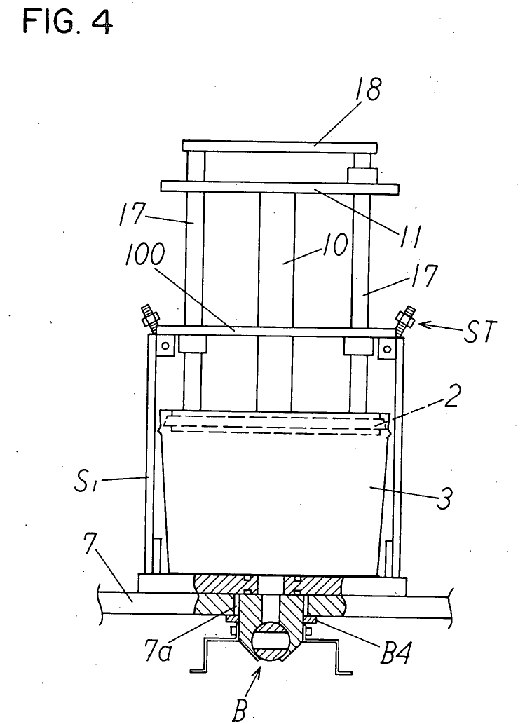

The lid member 2, the cylindrical member 10 and the opening portion 8a are initially disposed in such a way that the centers thereof correspond with each other, and the outside diameter of the lid member 2 and the inside diameter of the ink can 3 are also initially set so as to correspond with each other. Thus, in this positioning process, as shown in FIG. 3, the ink can 3 is positioned by moving it in such a way that the entirety of the outside periphery of the lid member 2 drops toward the inner wall of the ink can 3 that is positioned on the base 8, and makes contact with the inner wall of the ink can 3 (FIG. 4).

In order to bring the bottom end of the cylindrical member 10 into contact with the bottom of the ink can 3 from above the ink can 3 and at the same time, to bring the bottom of the ink can 3 into a pressure contact with the annular sealing member of the bottom of the can 9, the female screw of the nut S3 is fastened onto the male screw S2. Preferably, the bottom of the ink can 3 is brought into a pressure contact with the annular sealing member of the bottom of the can 9, by tightening the nut S3 somewhat firmly. After the aforementioned positioning process, the bottom of the ink can 3 is brought into a pressure contact with the annular sealing member of the bottom of the can 9 provided around the exterior of the opening portion 8a on the base 8 and this pressure contact condition is maintained (pressure contact process).

After this pressure contact process, the projection 12a at the front end of the advancing member 12 that is provided within the cylindrical member 10 is advanced toward the bottom of the ink can 3 so as to make a hole that connects with the opening portion 8a at the bottom of the ink can 3 (boring process). To advance the advancing member 12, the front end of the tool 13 is engaged with the concave portion 12c on the advancing member 12 and the tool 13 is rotated clockwise, as shown in FIG. 5.

After the aforementioned boring process, the front end of the projection 12a of the advancing member 12 is retracted so that it is located above the communication holes 10a that connect the interior of the cylindrical member 10 to the exterior (retraction process). The retraction of the advancing member 12 is carried out by rotating the tool 13 counterclockwise, in other words, inversely to the process of rotation that occurs at the time of advancing.

After this retraction process, ink within the ink can 3 is forced from above the lid member 2 and extracted through the communication hole 10a, through the hole 4 provided at the bottom of the ink can 3 and through the opening portion 8a (ink extraction process). In other words, when the valve B is opened and the motor 6 is driven, the front end of the male screw D1 of the lowering means D comes into contact with the connecting member 18, so that the connecting member 18 is pressed by a male screw D1 which is lowered and moved in a downward direction. Then, ink within the ink can 3 is forced out by the lid member 2 and extracted onto a tray T on the base 5 through the opening portion 8a of the cylindrical member 10, through the hole 4 and through the passage B1. When a detection is made to the effect that a set amount of ink has been extracted onto the tray T, the valve B2 is rotated so as to close the passage B1.

The positioning process is not restricted to the above-described example, but although not shown, in cases where the bottom of the ink can 3 has a recess, it is permissible to fit the outer periphery of the base 8 to this recess so that in this fitted condition the center of the cylindrical member 10 corresponds with the center of the opening portion 8a.

The stopper body ST is not restricted to the aforementioned one but may also be the one shown in FIG. 10.

In other words, a stopper body ST′ can be provided projectingly from a base (base 8 in FIG. 2, although not shown) and is comprised of an upright member S1′ that has a male screw S2 and that penetrates the hole 11C provided in the cylindrical attachment member 11 at the front end and a nut S3′ (a female screw body) that has a female screw which is fastened onto the male screw S2′ and whose rear face makes contact with the cylindrical attachment member 11. The female screw of the nut S3′ is fastened onto the male screw S2′ and at the same time, the nut S3′ is kept in a pressure contact with the surroundings of a hole 11C that is provided on the cylindrical attachment member 11. In consequence, the bottom of the ink can (ink can 3 in FIG. 8, although not shown) is kept in a pressure contact with the annular sealing member of the bottom of the can (sealing member of the bottom of the can 9 in FIG. 8, although not shown) through the cylindrical attachment member 11 and the cylindrical member (cylindrical member 10 in FIG. 2, although not shown)

The stopper body ST is not restricted to the aforementioned example, but may be comprised of an upright member S1″ which is provided projectingly from a base (base 8 in FIG. 2, although not shown), that has a female screw S3″ at its front end; a male screw S2″ which is fastened onto the female screw S3″ through a hole 11C that is provided on the cylindrical attachment member 11; and a male screw body S2″ that has a head portion, which is connected with the male screw S2″, which is larger than the outside diameter of the male screw. The male screw of this male screw body S2″ is fastened onto the female screw S3″, and the rear face of the head portion of the male screw body S2″ is maintained in a pressure contact with the surroundings of the hole 11C that is provided on the cylindrical attachment member 11. In consequence the bottom of the ink can (ink can 3 in FIG. 8, although not shown) is maintained in a pressure contact with the annular sealing member of the bottom of the can (the sealing member of the bottom of the can 9 in FIG. 8, although not shown) through the cylindrical attachment member 11 and the cylindrical member (cylindrical member 10 in FIG. 2, although not shown)

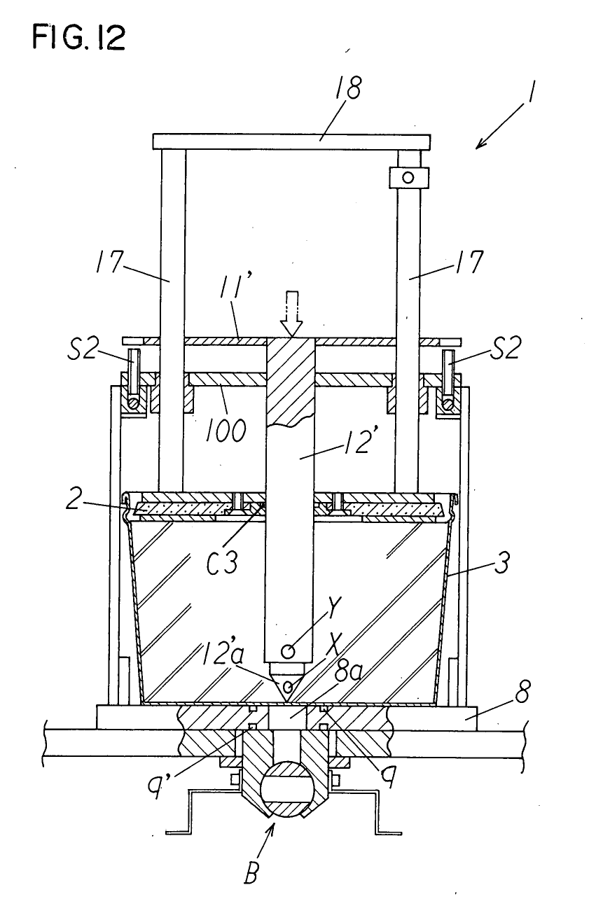

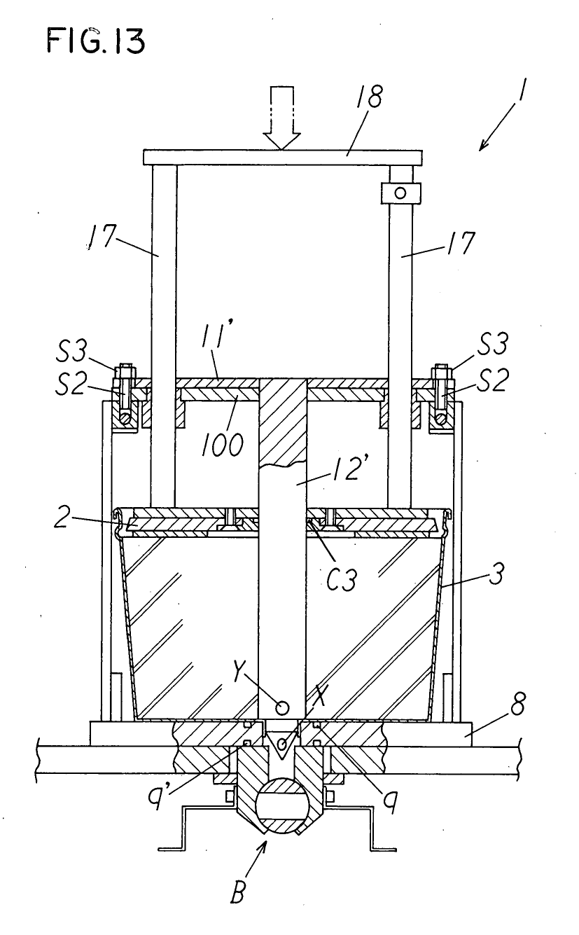

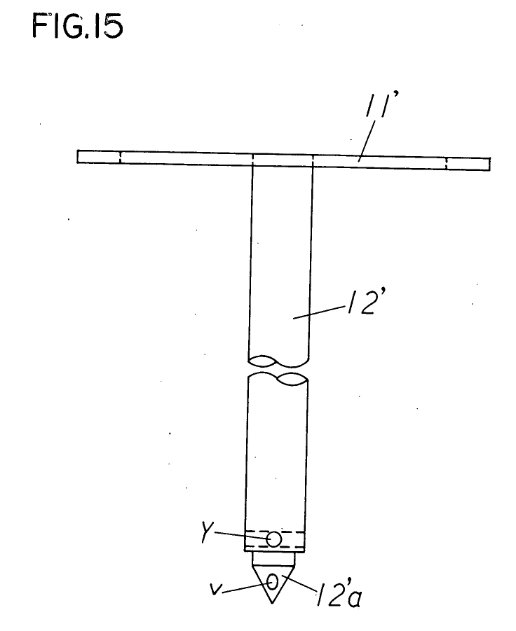

Although in the above-described embodiments, the cylindrical member 10 and the advancing member 12, which moves back and forth freely within this cylindrical member 10, are provided, the present invention need not be restricted to this example, and the cylindrical member 10 may be omitted (FIGS. 12-17). In this embodiment, identical reference numerals are credited to the same components as in the above embodiments, and a description thereof is partially omitted.

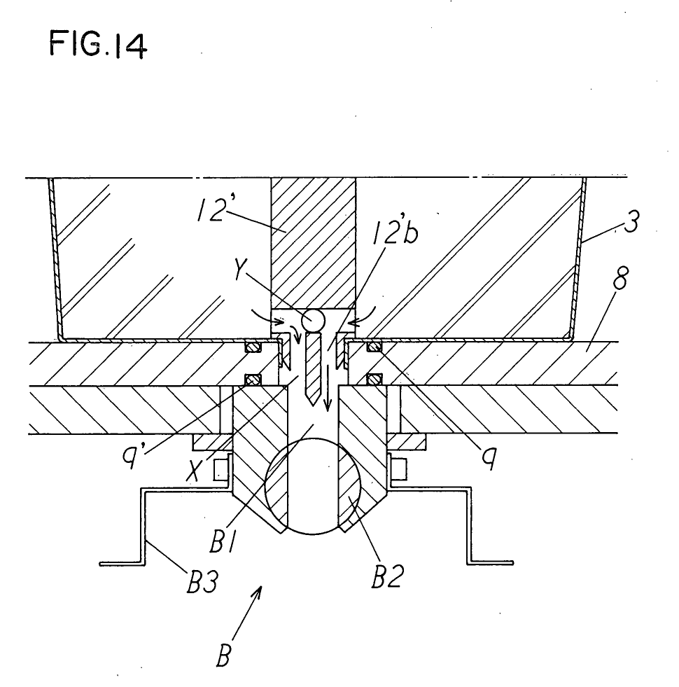

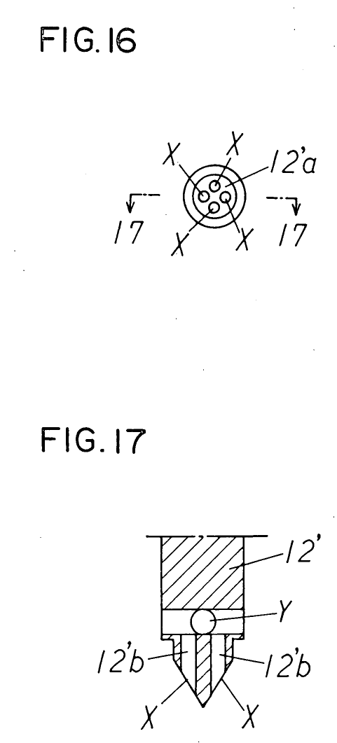

In FIGS. 12-17, reference numeral 12′ denotes a hole-boring member of the bottom of the can that has a projection 12′a for making a hole that connects with the opening portion 8a on the base 8 at the bottom of the ink can 3 at its front end. This hole-boring member of the bottom of the can 12′ has a communication hole 12′b (see FIGS. 14, 17) which connects the interior of the hole-boring member of the bottom of the can 12′ with the exterior. An end (opening portion X) of this communication hole 12′b is open from the projection 12′a of the hole-boring member of the bottom of the can 12′ and the other end (opening portion Y) of the communication hole 12′b is open from the side wall of the hole-boring member of the bottom of the can 12′ that is located above the projection 12′a.

Reference numeral 11′ denotes an attachment member for attaching the hole-boring member of the bottom of the can 12′ in such a way that the projection 12′a droops downward. An end portion on an opposite side to the projection 12′a on the hole-boring member of the bottom of the can 12′ is attached to the attachment member 11′ integrally. For purposes of the attachment, the end portion on an opposite side to the projection 12′a of the hole-boring member of the bottom of the can 12′ is caulked to an opening edge portion on the attachment member 11′.

Further, reference numeral 18 denotes a connecting member which is located above the attachment member 11′ and which connects the other ends of the plural rod-like members 17. An end of each of the plural rod-like members 17 is connected to the lid member 2, and the attachment member 11′ has holes through which the plural rod-like members 17 pass. The lid member 2 has a hole through which the outer periphery of the hole-boring member of the bottom of the can 12′ pass, the entirety of the outer periphery of the lid member 2 maintains contact with the inner wall of the ink can 3 and is located above the ink within the ink can 3. Reference numeral C3 denotes a sealing member which seals between the hole in the lid member 2 and the outer periphery of the hole-boring member of the bottom of the can 12′.

Thus, an ink can 3 containing ink with its lid opened is positioned on the base 8 and as seen from a side view, and as shown in FIG. 12, the hole-boring member of the bottom of the can 12′ is positioned inside the annular sealing member of the bottom of the can 9 that is located outside the opening portion 8a on the base 8 in such a way that, as seen in plan view, the annular sealing member of the bottom of the can 9 is situated outside of the hole-boring member of the bottom of the can 12′ (positioning process).

The lid member 2, the hole-boring member of the bottom of the can 12′ and the opening portion 8a are disposed in such a way that centers thereof coincide with one another. Further, because the outside diameter of the lid member 2 is set in advance to conform with the inside diameter of the ink can 3, in the positioning process, the ink can 3 is positioned by moving it in such a way that the entirety of the outer periphery of the lid member 2 as it descends along the inner wall of the ink can 3 maintains contact with the inner wall of the ink can 3.

After this positioning process, the projection 12′a at the front end of the hole-boring member of the bottom of the can 12′ is advanced toward the bottom of the ink can 3 so as to make a hole that connects with the opening portion 8a on the base 8 at the bottom of the ink can 3 (boring process).

Advancement of the hole-boring member of the bottom of the can 12′ in the direction of an arrow in FIG. 12 can be carried out on the basis of the principle of a lever with an end of a tool (not shown) set at an appropriate position of the ink extraction apparatus 1.

After this boring process, the annular sealing member of the bottom of the can 9 provided around the exterior of the opening portion 8a on the base 8 is brought into a pressure contact with the bottom of the ink can 3 on the side on which the ink can 2 is to be positioned on the base 8, and this pressure contact condition is maintained (maintaining of pressure contact process).

For the purposes of the maintaining of pressure contact, the female screw of the nut S3 is fastened onto the male screw S2 in order to keep the bottom of the ink can 3 in a pressure contact with the annular sealing member of the bottom of the can 9. Preferably, the bottom of the ink can 3 is brought into a pressure contact with the annular sealing member of the bottom of the can 9 by tightening the nut S3 somewhat firmly.

After this pressure contact maintaining process, ink within the ink can 3 is forced from above by the lid member 2 so as to extract ink through the communication hole 12′b and through the opening portion 8a on the base 8 (ink extraction process).

More specifically, when the motor 6 shown in FIG.1 is driven with a valve B that has been opened (see FIG. 14), the front end of the male screw D1 of the lowering means D comes into contact with the connecting member 18 and then, the connecting member 18 is pressed by the male screw that is moving down and is itself moved in a downward direction, so that ink within the ink can 3 is forced out by the lid member 2 and extracted onto the tray T of the base 5, as shown in FIG. 1, through the communication hole 12′b and through the opening portion 8a on the base 8. When a detection is made to the effect that a set amount of ink has been extracted onto the tray T, the valve B2 is rotated in such a way as to close the passage B1.

Thus, in this ink extraction apparatus 1 (ink extraction method), the hole-boring member of the bottom of the can 12′ is situated inside the annular sealing member of the bottom of the can 9 as seen in plan view, and leakage of ink can be prevented as a hole is being bored in the bottom of the ink can 3. Further, ink can be extracted through the communication holes 12′b in the hole-boring member of the bottom of the can 12′ within the ink can 3.

Although in the previously described embodiment, in order to extract ink, the advancing member 12 (the hole-boring member of the bottom of the can 12′) needs to be returned in an upward direction so as to restore to a mutually communicating condition between the communication hole in the cylindrical member, the hole provided in the bottom of the ink can and the opening portion in the base, according to this ink extraction apparatus 1 (ink extraction method), the hole-boring member of the bottom of the can 12′ does not need to be returned in an upward direction after a hole has been bored in the bottom of the ink can 3 with the projection 12′ at the front end of the hole-boring member of the bottom of the can 12′. Cut out pieces from the bottom of the ink can 3 that have been generated by the projection 12′a at the front end of the hole-boring member of the bottom of the can 12′ extend from the interior of the ink can 3 to the exterior, thereby causing no problem when ink from within the ink can 3 is forced by a lid member 2 that is going down (If, in contrast, a hole is bored at the bottom of the ink can from the exterior of the ink can to the interior, cut out pieces from the bottom in which a hole has been bored are situated inside the ink can, thereby creating a problem that the pieces that have been cut out obstruct extraction of the ink when ink is forced out by contact member that is moving down.

What is claimed is:

1. An ink extraction apparatus comprising:
an ink can containing ink;
a base on which the ink can can be positioned and which has an opening portion;
an annular sealing member of the bottom of the can provided around the exterior of the opening portion on the base on a side on which the ink can of the base is positioned;
a cylindrical member whose bottom end is in contact with the bottom of the ink can positioned on the base;
a cylindrical attachment member on which the cylindrical member is to be attached in such a way that it droops,
the cylindrical member having a communication hole that connects the interior of the cylindrical member with the exterior,
the bottom end of the cylindrical member that, as seen in plan view, is located inside the annular sealing member, in such a way that the center of the cylindrical member coincide with the center of the opening portion,
an advancing member which is provided so as to be freely movable in a back and forth direction within the cylindrical member, and which has a projection for making a hole for communicating with the opening portion at the bottom of the ink can at a front end thereof;
a sealing member for sealing between the outer periphery of the advancing member and the inner periphery of the cylindrical member;
a lid member which has a hole through which the outer periphery of the cylindrical member passes, in which the entire outer periphery is contiguous with the inner wall of the ink can and which is located above the ink within the ink can;
a plurality of rod-like members connected to the lid member;
a connecting member for connecting the other end of each of the plurality of the rod-like members;
a lowering means for lowering the connecting member toward the opening portion; and
a stopper body which blocks the cylindrical member from moving in the direction of leaving the opening portion and which is provided outside the ink can positioned on the base so as to maintain a condition in which the bottom end of the cylindrical member maintains contact with the bottom of the ink can.

2. The ink extraction apparatus according to claim 1 wherein the stopper body comprises an upright member that is erected from the base, a male screw attached rotatably to the upright member and a nut having a female screw that is fastened onto the male screw; and
the female screw of the nut is fastened onto the male screw and the nut is kept in a pressure contact with the surrounding of a cut out portion provided on the cylindrical attachment member so that the bottom of an ink can can be kept in a pressure contact with the annular sealing member of the bottom of the can through the cylindrical attachment member and the cylindrical member.

3. The ink extraction apparatus according to claim 1 wherein the stopper body comprises an upright member erected from the base and has a male screw that penetrates a hole provided in the cylindrical attachment member at a front end thereof and a nut having female screw which is fastened onto the male screw and whose rear face makes contact with the cylindrical attachment member; and
the female screw of the nut is fastened onto the male screw, and the nut is kept in a pressure contact with the surroundings of a hole provided in the cylindrical attachment member, so that the bottom of the ink can can be kept in a pressure contact with the annular sealing member of the bottom of the can through the cylindrical attachment member and the cylindrical member.

4. The ink extraction apparatus according to claim 1 wherein the stopper body comprises an upright member erected from a base and having female screw at a front end thereof; a male screw that is fastened onto the female screw through a hole provided in the cylindrical attachment member; and a female screw body which is connected with the male screw and which has a head larger than the outside diameter of the male screw; and
the male screw of the male screw body is fastened onto the female screw, and the rear face of the head portion of the male screw body is kept in a pressure contact with the surroundings of a hole provided in the cylindrical attachment member, so that the bottom of the ink can can be maintained in a pressure contact with the annular sealing member of the bottom of the can through the cylindrical attachment member and the cylindrical member.

5. An ink extraction apparatus comprising:
an ink can containing ink;
a base on which the ink can is positioned and which has an opening portion;
an annular sealing member of the bottom of the can provided around the exterior of the opening portion on the base, on a side on which the ink can of the base is positioned;
a hole-boring member of a bottom of a can having a projection for making a hole that communicates with the opening portion of the base at the bottom of the ink can at a front end thereof;
an attachment member on which the hole-boring member of the bottom of a can is mounted in such a way that the projection droops downward;
the hole-boring member of the bottom of the can having a communication hole that communicates the interior of the hole-boring member of the bottom of the can with the exterior while an end of the communication hole that has been opened in the projection of the hole-boring member of the bottom of the can and the other end of the communication hole that has been opened in a side wall of the hole-boring member of the bottom of the can are both located above the projection,
the hole-boring member of the bottom of the can, as seen in plan view, being located inside the annular sealing member,
a lid member which has a hole through which the outer periphery of the hole-boring member of the bottom of the can passes, and whose outer periphery makes contact with the inner wall of the ink can, the lid member being located above the ink in the ink can;
a sealing member for sealing between the hole in the lid member and the outer periphery of the hole-boring member of the bottom of the can;
the attachment member having holes through which the outer peripheries of the plural rod-like members pass,
a connecting member located above the attachment member for connecting the other ends of the plural rod-like members; and a lowering member for lowering the connecting member toward the opening portion on the base.

6. An ink extracting method comprising:
a positioning step of positioning a bottom end of a cylindrical member with the bottom of the ink can positioned on a base having an opening portion, in such a way that the center of the cylindrical member coincides with the center of the opening portion;
a pressure contact maintaining step by bringing the annular sealing member of the bottom of the can provided around the exterior of the opening portion on the base into contact with the bottom of the ink can, and maintaining the pressure contact condition;
a boring process of advancing a projection at the front end of an advancing member provided within the cylindrical member so as to make a hole that communicates with the opening portion in the bottom of the ink can after the pressure contact maintaining step;
a retraction step of after the hole-boring step, retracting the front end of the projection of the advancing member in such a way that it becomes located above the communication hole that connects the interior of the cylindrical member with the exterior; and
an ink extracting step of after the retraction step, by forcing ink in the ink can from above with the lid member so as to extract ink through the communication hole, through a hole provided at the bottom of the ink can and through the opening portion.

7. The ink extraction method according to claim 6 wherein the lid member having a hole through which the outer periphery of the cylindrical member passes, and whose entire outer periphery thereof makes contact with the inner face of the ink can while being located above ink in the ink can is provided in such a way that it is capable of being lifted up and down, and the lid member, the cylindrical member and the opening portion are disposed in such a way that the centers thereof coincide, and the outside diameter of the lid member coincides with the inner side of the ink can,
and in the positioning step the ink can is moved in conditions in which the outer periphery of the lid member is lowered along the inner face of the ink can installed on the base and makes contact with the entire inner wall of the ink can.

8. An ink extraction method by using an ink extraction apparatus comprising:
an ink can containing ink;
a base on which the ink can is positioned and which base has an opening portion;
an annular sealing member of the bottom of the can provided around the exterior of the opening portion on the base, on a side on which the ink can of the base is positioned;
a hole-boring member of the bottom of a can whose bottom end has a hole-boring projection that makes contact with the bottom portion of the ink can positioned on the base;
an attachment member on which projection of the hole-boring member of the bottom of a can is to be attached in such a way that it droops,
the hole-boring member of the bottom of a can having a communication hole that connects the interior of the cylindrical member with the exterior, one end of the communication hole being opened on the projection of the hole-boring member of the bottom of a can and the other end of the communication hole being opened on an inner wall of the hole-boring member of the bottom of a can that is positioned above the projection, in such a way that the bottom end of the cylindrical member being located inside the annular sealing member as seen in plan view, in such a way that the center of the hole-boring member of a can corresponds with the center of the cylindrical sealing member,
a lid member which has a hole through which the outer periphery of the hole-boring member of the bottom of a can is passed, which makes an inner wall of the ink can over an entire outer periphery thereof, and which is located above the ink within the ink can; a sealing member for sealing between the outer periphery of the hole-boring member of the bottom of the can and the hole of the lid member;
a plurality of rod-like members connected to the lid member;
a connecting member for connecting the other end of each of the plurality of the rod-like members;
a lowering means for lowering the connecting member toward the opening portion; and
a stopper body which blocks the hole-boring member of the bottom of the can from moving in the direction of moving away from the opening portion, and which is provided outside the ink can on which the base is positioned so as to maintain a condition in which the bottom end of the hole-boring member maintains contact with the bottom portion of the ink can,
the ink extraction method comprising:
a positioning step of positioning the hole-boring member of the bottom of the can inside the annular sealing member of the bottom of the can located outside the opening portion on the base as seen in plan view;
a hole-boring step of after the positioning step, by advancing the projection at the front end of the hole-boring member of the bottom of the can toward the bottom of the ink can so as to make a hole that makes a connection with the opening portion at the bottom portion of the ink can;
a pressure contact maintaining step of after the hole-boring step, by bringing the bottom of the ink can into a pressure contact with the annular sealing member of the bottom of the can provided around the outside of the opening portion on the base on a side on which the ink can of the base is positioned, and by maintaining a pressure contact condition; and
an ink extracting step of after the pressure contact maintaining step, by forcing ink within the ink can from above with the lid member so as to extract the ink through the communication hole and the opening portion.
